(19) United States
(12) Patent Application Publication
(10) Pub. No.: US 2020/0210541 A1
(43) Pub. Date: Jul. 2, 2020

(54) Detection of Lithium Plating Potential with Multi-Particle Reduced-Order Model

(71) Applicant: SF Motors, Inc., Santa Clara, CA (US)

(72) Inventors: Sangwoo Han, Mountain View, CA (US); Saeed Khaleghi Rahimian, San Jose, CA (US); Mehdi Forouzan, Santa Clara, CA (US); Ying Liu, Santa Clara, CA (US); Yifan Tang, Santa Clara, CA (US)

(73) Assignees: Chongqing Jinkang New Energy Vehicle, Ltd., Chongqing (CN); SF Motors, Inc., Santa Clara, CA (US)

(21) Appl. No.: 16/237,526

(22) Filed: Dec. 31, 2018

(51) Int. Cl. G06F 17/50; H01M 10/0525; H01M 10/02

(52) U.S. Cl. CPC G06F 17/5009; H01M 10/02; H01M 10/0525

(57) ABSTRACT

A multiple particle reduced order model accurately predicts lithium plating potential in real time during the life of a lithium battery cell. In the current multi-particle reduced order modeling system, the current density and the potential distributions are solved iteratively. Once the current distribution is solved, lithium concentration distribution is solved without involving any iterative process. By solving the lithium concentration distribution as a separate step after the iteratively determined current density and potential distributions, the computation time required by the model to generate an output is dramatically reduced by avoiding solving multiple partial derivative equations iteratively. Based on the potential distribution information provided by the output of the model, lithium plating potential can be determined and actions can be taken, such as modified charging techniques and rates, to minimize future lithium plating.

### BACKGROUND

Lithium batteries are used in many modern devices, including electric vehicles, computers, and cell phones. One attractive aspect of lithium-ion batteries is that they may be fast charged at a quicker rate than other rechargeable batteries. Fast charging does, however, have disadvantages. For example, fast charging can cause an accelerated capacity fading, resulting in the possibility of triggering a safety issue. During fast charging, lithium-ions tend to plate on the negative active material surface instead of intercalating into the material. Once lithium ions are plated, the lithium-ion battery degrades in several ways, including but not limited to creating an electrical pathway between the active material and the electrolyte through a solid electrolyte interface (SEI), exposing electrons to the electrolyte.

To minimize lithium metal plating, battery cells have been subject to extensive lithium plating tests to determine the maximum region and continuous charging current limits as a function of a state of charge (SOC) and temperature. However, practical models that are usable in real time and provide accurate results are not available by systems and processes of the prior art.

### SUMMARY

The present technology, roughly described, utilizes a multiple particle reduced order model to accurately predict lithium plating potential in real time during the life of a lithium battery cell. The battery model can be based on several observations and assumptions, such as for example that cell voltage protection with a single particle reduced order model is accurate for a low or pulsing electrical load when a lithium concentration and potential gradient inside a cell is negligible. In the current multi-particle reduced order modeling system, only the current density and the potential distributions are solved iteratively. This is based on a premise that the electrical field and the charge transfer action processes occur at a smaller timescale than the diffusion timescale.

Once the current distribution is solved, lithium concentration distribution is solved without involving any iterative process. By solving the lithium concentration distribution as a separate step after the iteratively determined current density and potential distributions, the computation time required by the model to generate an output is dramatically reduced by avoiding solving multiple partial derivative equations iteratively. The accuracy of potential distribution within a cell is significantly improved compared to a single particle base model. Based on the potential distribution information provided by the output of the model, lithium plating potential can be determined and actions can be taken, such as modified charging techniques and rates, to minimize future lithium plating.

In embodiments, a method is disclosed for modeling a battery cell to detect lithium ion plating potential that may lead to battery cell degradation. The method may include setting a lithium ion concentration for a model battery by a battery management system on a battery-powered system. The battery model can provide a model for the battery cell on the battery-powered system. A temperature of the battery cell on the battery-powered system can be predicted in the model battery, and the temperature can be set as the modeled battery cell temperature. Material properties for the model battery can be set based at least in part on the modeled battery temperature. The potential distribution and current density for the model battery can be iteratively determined by the battery management system. A lithium plating potential for the model battery can then be calculated by the battery management system based at least in part on the potential distribution.

In embodiments, a non-transitory computer readable storage medium includes a program, the program being executable by a processor to perform a method for modeling a battery cell to detect battery cell degradation. The method may include setting a lithium ion concentration for a model battery by a battery management system on a battery-powered system. The battery model can provide a model for the battery cell on the battery-powered system. A temperature of the battery cell on the battery-powered system can be detected, and the model battery temperature can be set as the battery cell temperature. Material properties for the model battery can be set based at least in part on the modeled battery temperature. The potential distribution and current density for the model battery can be iteratively determined by the battery management system. A lithium plating potential for the model battery can then be calculated by the battery management system based at least in part on the potential distribution.

In embodiments, a system for modeling a battery cell to detect battery cell degradation includes one or more processors, memory, and one or more modules stored in memory and executable by the one or more processors. When executed, the modules may set a lithium ion concentration for a modeled battery by a battery management system on a battery powered system, the battery model providing a model for a battery cell on the battery powered system, detect a temperature of the battery cell on battery powered system and setting the modeled battery temperature as the battery cell temperature, set material properties for the modeled battery based at least in part on the modeled battery temperature, iteratively determine potential distribution and current density for the modeled battery by the battery management system, and calculate a lithium plating potential for the modeled battery by the battery management system based at least in part on the potential distribution.

### BRIEF DESCRIPTION OF FIGURES

FIG. 1 is a block diagram of a battery powered system.

FIG. 2 is a block diagram of a lithium battery cell during charging.

FIG. 3 is a block diagram of a lithium battery cell during discharge.

FIG. 4 is a block diagram of a lithium battery cell exhibiting lithium metal plating.

FIG. 5 is a block diagram of a battery management system.

FIG. 6 is a block diagram of a battery modeling module.

FIG. 7 is a method for detecting lithium plating using a reduced order model.

FIG. 8 is a method for modeling a battery using a reduced order model.

FIG. 9 is a method for iteratively determining the current density and potential distribution.

FIG. 10 is a block diagram of a computing environment for implementing in the present technology.

### DETAILED DESCRIPTION

The present technology, roughly described, utilizes a multiple particle reduced order model to accurately predict lithium plating potential in real time during the life of a lithium battery cell. The battery model can be based on several observations and assumptions, such as for example that cell voltage protection with a single particle reduced order model is accurate for a low or pulsing electrical load when a lithium concentration and potential gradient inside a cell is negligible. Under a continuous electrical load such as during charging, however, the single particle model prediction will start to deviate from the measurement. This is due to the model being forced to use the average current density in the calculation.

In a full order model, the current density distribution, potential distribution such as the electrode potential and electrolyte potential, and the lithium concentration distribution are mutually dependent. Because the model is highly nonlinear, the model solution needs to be solved iteratively. In the current multi-particle reduced order modeling system, only the current density and the potential distributions are solved iteratively. This is based on a premise that the electrical field and the charge transfer action processes occur at a smaller timescale than the diffusion timescale.

Once the current distribution is solved, lithium concentration distribution is solved without involving any iterative process. By solving the lithium concentration distribution as a separate step after the iteratively determined current density and potential distributions, the computation time required by the model to generate an output is dramatically reduced by avoiding solving multiple partial derivative equations iteratively. The accuracy of potential distribution within a cell is significantly improved compared to a single particle base model. Based on the potential distribution information provided by the output of the model, lithium plating potential can be determined and actions can be taken, such as modified charging techniques and rates, to minimize future lithium plating.

The modeling technique of the present technology provides advantages over other modeling techniques and that it provides accurate results and can be implemented in real time, for example on a battery-powered system such as an electric vehicle, computer, mobile phone, or other device. Real-time applications of a physics-based model by prior systems are limited due to the high computational cost. In a lithium-ion battery cell model, many particles are considered to represent an electrode to capture current density and potential distribution inside the battery cell. The process of modeling is computationally intensive as it involves iteratively solving many partial differential equations. To reduce computation time for real-time application, a common model reduction scheme is to consider a single particle to represent an electrode. In some and set of solving multiple partial differential equations at each discrete time step, only a single partial differential equation needs to be solved with a single particle model. With this approach, however, the accuracy is poor because it cannot capture spatial dependent current density distribution. Any reliance on such a model to detect and avoid lithium plating will lead to erroneous results.

The technical problem addressed by the present technology relates to identifying degradation in batteries by modeling a battery cell. In some prior solutions degradation in batteries, such as lithium plating, is determined by modeling the battery. To provide an accurate model, a battery is modeled using multiple particles to represent each electrode. Though the typical multiple particle electrode model can provide accurate results, it requires large computational resources, cannot provide results in real time, and is not practical for use in consumer systems. Other models represent electrodes as a single particle rather than multiple particles, and require much less computational cost. A single particle electrode model, however, has the disadvantage of not providing very accurate results, which can lead to incorrect lithium plating detection and prediction.

The present technology provides a technical solution to the technical problem of modeling a battery cell in real time so that the model can be used by a battery powered system with the battery being modeled. The battery cell model of the present technology provides a multi-particle reduced order model that iteratively determines the current density and potential distribution, and then determines a lithium plating potential as a separate non-iterative step after the iterative process is done. By determining the lithium plating potential as a separate step after the iterative process, a very large computational cost is avoided, which provides a more efficient computational process for implementing the lithium battery model. Further, by providing a model that addresses multiple particle electrodes rather than representing each electrode as a single particle, the model is much more accurate than models representing electrodes as single particles, providing a much more reliable lithium plating potential determination.

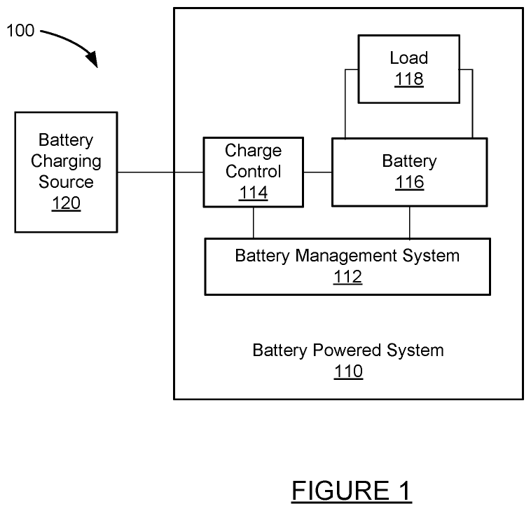

FIG. 1 is a block diagram of a battery powered system 100. Battery powered system 100 includes battery-powered system 110 and battery charging source 120. Each of systems 110- and 120 may be coupled with and communicate over one or more networks, including but not limited to public networks, private networks, cellular networks, wireless networks, the Internet, an intranet, a WAN, a LAN, a BLUETOOTH or other radio frequency signal, a plain-old-telephone-service (POTS), and/or any other network suitable for communicating digital and/or analog data over.

The elements illustrated in FIG. 1 are depicted in a manner and organization intended to be exemplary, and are not intended to be limiting. For example, battery charging source 120 and battery powered system 110 may each be implemented as one or more machines, servers, logical machines or servers, and may be separately implemented from or completely and/or partially combined with each other.

The data processing discussed herein is also discussed in a manner and organization intended to be exemplary, and it not intended to be limiting. For example, although an exemplary process is described in which data is retrieved from a battery 116 and processed by battery management system 112, the data may be retrieved by, processed in whole or in part, and transmitted in raw or processed form between different machines, servers and systems, modules and sub-modules, whether or not illustrated in FIG. 1.

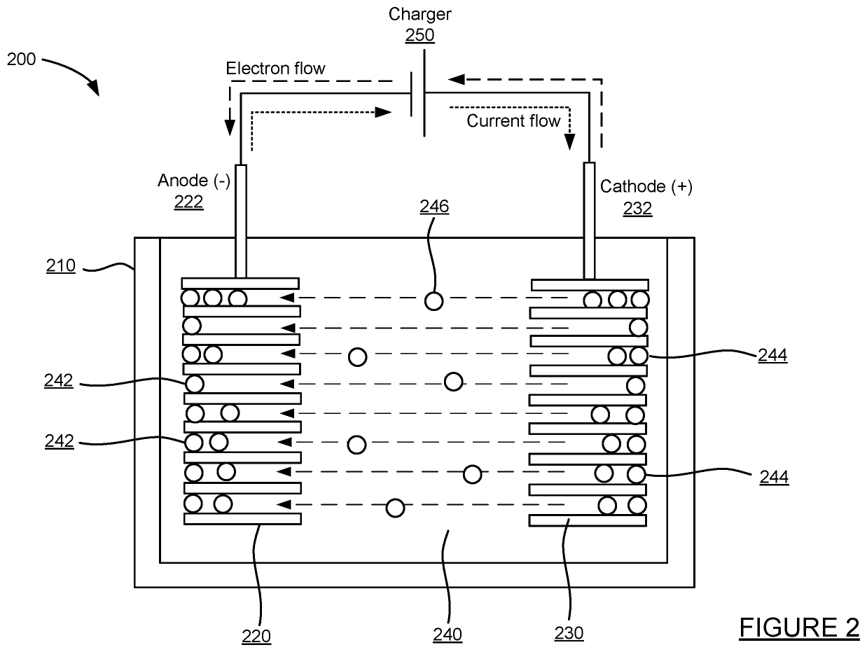

Battery-powered system 110 may implement a system or product that utilizes a battery. Examples of a battery-powered system 110 include an electronic vehicle, mobile phone, computer, or some other device that utilizes a battery. Battery-powered system 110 includes battery management system 112, charge control 114, battery 116, and load 118. Battery-powered system 110 may receive a charge for battery 116 from battery charging source 120. The charge provided by source 120 may be received by charge control 114, which may then apply the charge the battery 116. In some instances, charge control 114 may communicate with battery management system 112 regarding how to apply a charge to better 116. For example, battery management system 112 may specify to charge control 114 a C-rate at which battery 116 may be charged, including the voltage and current at which to charge the battery 116. Battery management system may determine the voltage and current at which battery 116 should be charged based on a default voltage and current or customize voltage and current based on battery conditions detected or determined to exist by battery modeling. Load 118 may include one or more loads internal to or external to battery-powered system 110 to which battery 116 is to provide power. More details for battery 116 are discussed with respect to FIGS. 2-4.

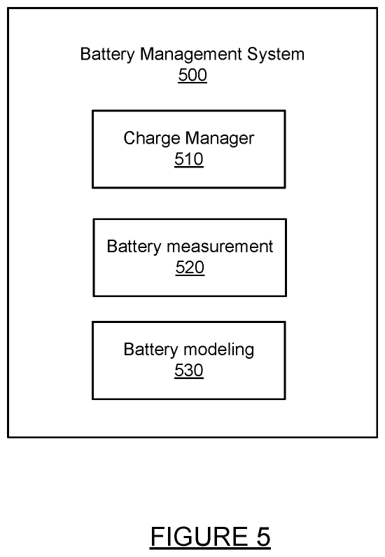

BMS 112 may be implemented as hardware and/or software that controls and measures batter 114, and controls charging of battery 114 on system 110. BMS may include logic, modules, and components to provide a multiple particle reduce order model of battery 116. The battery model may be used to determine lithium plating potential in real time such that lithium plating in battery 116 can be detected and steps may be taken to reduce any such plating in the future. More detail for BMS 112 are discussed with respect to FIG. 5.

Battery charging source 120 may include any suitable source of charge for charging a battery 114. In some instances, in the case of a system 110 implemented as an electronic vehicle, battery charging source 120 may be a dealership, charging pump, or a power outlet commonly found in a home, business or other building. When system 110 is implemented as a phone or computer, a suitable battery charging source 120 may include a mobile charging pack, car charger, or power outlet found in a home, business or other building.

FIG. 2 is a block diagram of a lithium battery cell 200 during charging. Battery cell 200 provides more detail of battery 116 in the system of FIG. 1. Battery cell 200 includes anode 222, cathode 232, lithium ions 242, 244, and 246, and electrolyte 240. The anode includes active material 220 and the cathode material includes active material 230. Electrolytes 240 are placed in a battery cell container 210 with the anode material 220 and cathode material 230. When the lithium battery is charged, charger 250 applies a potential between the anode and cathode. During charging, lithium ions 244 move from the positive cathode electrode 230 through the electrolyte (see lithium ions 246) and towards the negative anode electrode 220, where the lithium ions 242 are embedded into the anode via intercalation. The electrons travel from the cathode to the anode, causing current to travel from the anode to the electrode.

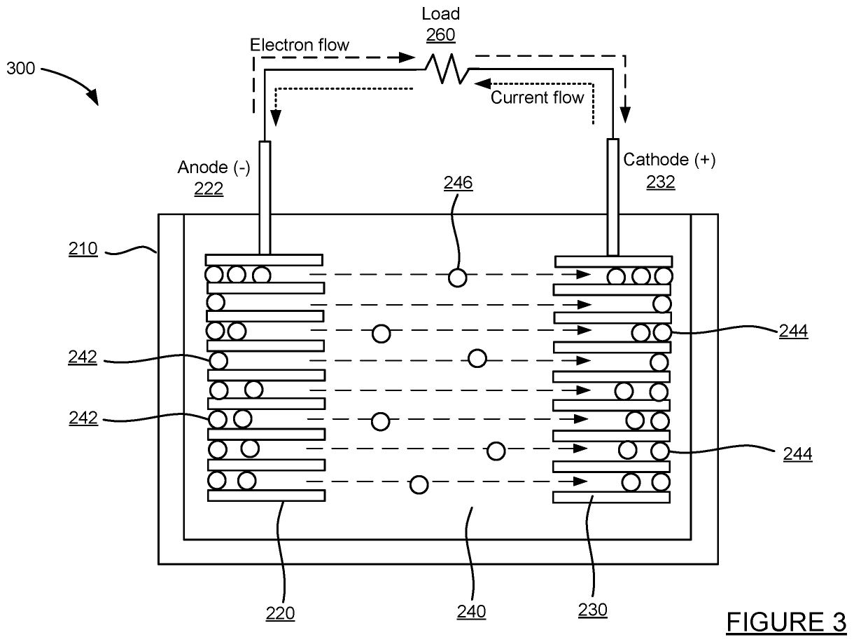

FIG. 3 is a block diagram of a lithium battery cell during discharge. During discharge, the lithium ions 242 collected at the anode move through the electrolyte (see lithium ions 246) to position at and within the cathode as lithium ions 244, resulting in a potential applied to load 260. During discharge, electrons travel from the anode to the cathode, causing current to travel from the cathode to the anode.

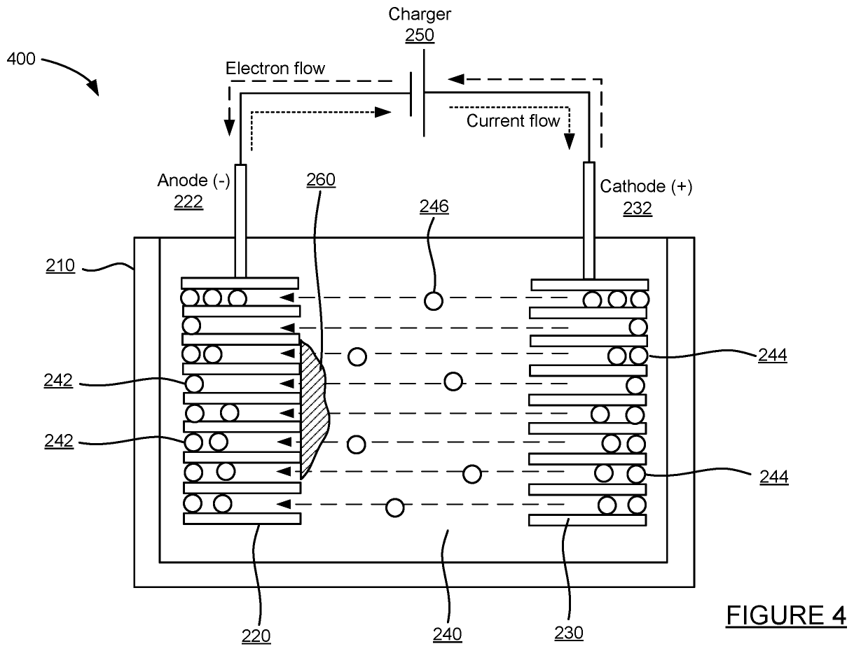

FIG. 4 is a block diagram of a lithium battery cell exhibiting lithium metal plating. During a charging process, lithium-ion batteries sometimes experience a phenomenon known as lithium metal plating. As lithium ions travel from a cathode to an anode, sometimes, due to the charge voltage or higher than desired temperatures, the lithium-ions arrive at the anode more quickly than the ions can intercalate within the anode structure. As a result, some lithium-ion's “plate” on the anode. The plated lithium ions 260 reduce intercalation of other ions within the anode, reduce the capacity of the cell, and can lead to other undesirable issues within a lithium battery.

FIG. 5 is a block diagram of a battery management system. Battery management system 500 of FIG. 5 includes a charge manager 510, battery management 520, and battery modeling 530. Charge manager 510 may control the voltage, current, duration, and other aspects of charging of a battery within a battery-powered system. Battery management 520 may measure aspects of the battery-powered system, the battery, a charge received from an outside source, and other aspects of the battery system of a battery-powered system.

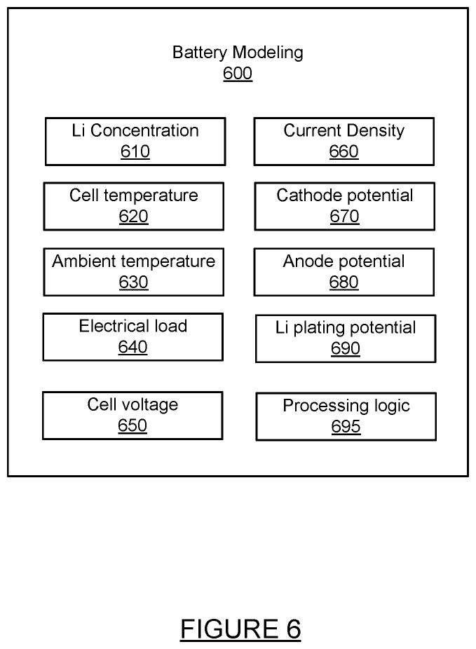

Battery modeling 530 may model a battery 116 of a battery-powered system. The battery modeling may utilize a multi-particle reduce order model to provide accurate modeling for the battery within a system in real time. The battery model may receive inputs of applied electrical load and ambient temperature, and may output cell voltage, temperature, electric potential distribution including electrode potential lithium plating potential, and the concentration distribution inside the battery cell. The ambient temperature may be measured and provided, or in some instances may be predicted and then provided to the model. The prediction can involve, in some instances, thermal energy balancing techniques. Battery modeling 530 may iteratively determine a current density and potential distribution, and then use that information to determine the lithium plating potential. Battery modeling 530 may also communicate with charge manager 510 to indicate that lithium plating exists within the battery 116. In response, charge manager 510 may adjust a charging process of battery 116 to set a voltage and current during charge to minimize or eliminate further lithium plating. More detail for battery modeling 530 is discussed with respect to FIG. 6.

The elements of BMS 112 may be implemented as software modules stored in memory and executed by one or more processors, hardware components, or a combination of these. Further, the elements listed and BMS 112 are exemplary, and more or fewer elements may be implemented to perform the functionality described herein.

FIG. 6 is a block diagram of a battery modeling module. Battery modeling module 600 generates, provides input to, and transmits the output from a multiple particle reduce order model used for modeling a battery 116 and determining lithium plating potential of battery 116. Battery modeling module 600 may include parameters for the model, material properties for battery materials, and processing logic which may include algorithms, iterative engines, and other logic for executing the model. As shown in FIG. 6, battery modeling module 600 may include parameters of lithium concentration 610, cell temperature 620, ambient temperature 630, electrical 640, cell voltage 650, current density 660, cathode potential 670, anode potential 680, lithium plating potential 690, and processing logic 695. Battery modeling module 600 may perform operations discussed herein associated with modeling a battery 116. The modules listed in battery modeling module 600 are exemplary, and more or fewer elements may be implemented to perform the functionality described herein.

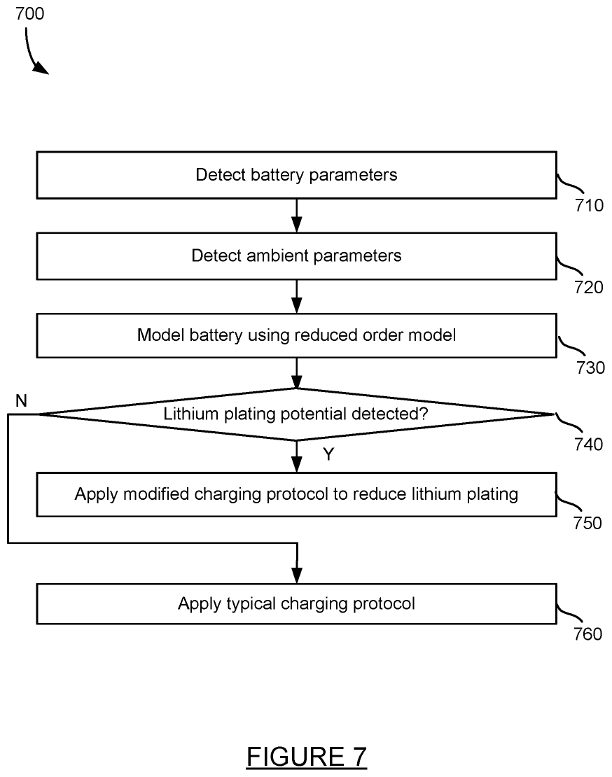

FIG. 7 is a method for detecting lithium plating using a reduced order model. Battery parameters may be detected at step 710. The battery parameters may include a cell temperature, cell voltage, a state of charge, and other parameters. Ambient parameters may be detected at step 720. The ambient parameters may include the ambient temperature and other environment parameters.

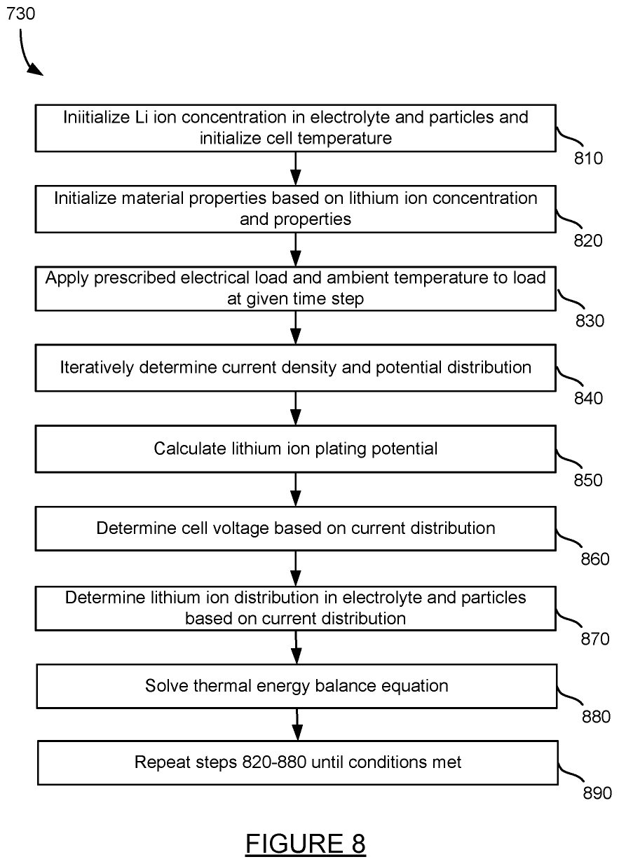

A battery may be modeled using a reduced order model at step 730. The model may implement a multiple particle reduce order model, which saves considerable computational resources by iterating a current density and potential distribution iteratively, while determining a lithium plating potential as a separate step after the iterator process is complete. More detail for modeling a battery using a reduced order model is discussed with respect to the method of FIG. 8.

A determination is made as whether a lithium plating potential that indicates the presence of lithium plating is detected at step 740. In some instances, a lithium plating potential having a value of less than zero indicates that lithium plating has occurred. If the lithium plating potential indicates the presence of lithium plating, a modified charging protocol is applied to a battery in order to reduce lithium plating at step 750. In some instances, a charging process to reduce lithium plating may involve applying a much lower charging rates to the battery, such as C/50. If, at step 740, no lithium plating is detected based on the lithium plating potential, a typical charging protocol may be applied at step 760.

FIG. 8 is a method for modeling a battery using a reduced order model. The method of FIG. 8 provides more detail for step 730 of the method of FIG. 7. First, lithium ion concentrations for electrolytes and particles are initialized along with the cell temperature at step 810. Material properties based on a lithium-ion concentration are initialized at step 820. The material properties may include diffusion within particles, diffusion within the electrolyte, conductivity within the electrolyte, electrical conductivity of the electrolyte, an electrode reaction rate constant, and other properties.

A prescribed electrical load and ambient temperature are applied to the load of the battery model at step 830. The load is determined by an actual load 118 applied to actual battery 116 in the system of FIG. 1.

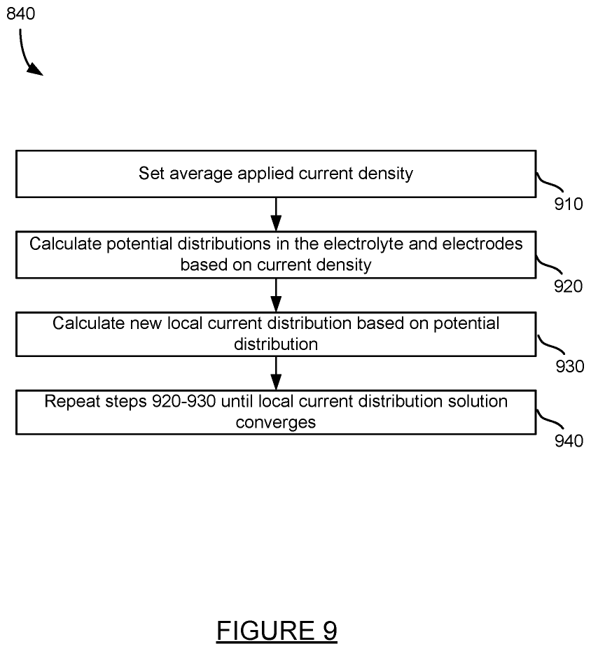

The current density and potential distribution for the battery are iteratively determined at step 840. For each time step, the current density distribution and potential distributions, including electrode potential and the electrolyte potential, are determined in an iterative manner. Iteratively determining the current density and potential distributions are discussed in more detail with respect to the method of FIG. 9.

A lithium-ion plating potential is calculated at step 850. In some instances, a lithium-ion plating material is determined after the iterative calculations are complete. Lithium-ion plating potential can be estimated as a function of one or more of the electrode potential φₛ, electrolyte potential φₑ, current i, and a resistance of a solid electrolyte interphase (SEI) film R_{film} formed within the battery cell. In some instances, lithium-ion plating potential can be determined as follows:

φ_{Li}=φₛ−φₑ−iR_{film}.

A cell voltage based on the current distribution may then be determined at step 860. A lithium-ion distribution in electrolyte and particles can be determined based on the current distribution at step 870. A thermal energy balance equation for this model battery cell can be solved at step 880, and steps 820-880 can be repeated until any user conditions are met, if any.

FIG. 9 is a method for iteratively determining the current density and potential distribution. An average applied current density is set at step 910. A current density can be calculated as the applied current divided by the area of the cell through which the current passes. The applied current is a function of the electrode potential and the electrolyte potential, both of which are in turn are a function of the current density. The potential distributions in electrolyte and electrodes are calculated based on the set current density at step 920. The electrode potential and electrolyte potential are calculated for the whole domain, and based on that information the current distribution can be calculated. A new local current distribution is calculated based on the potential distribution, including electrolyte potential and the electrode potential, at step 930. In some instances, the new local current distribution is calculated based on the Butler-Vollmer reaction kinetics equation. Steps 920 and 930 are repeated until the local current distribution solution converges, for example until a relative tolerance is met. In some instances, steps 910 and 920 repeated wherein with each iteration, the integral of the updated local current distribution within each electrode equals the applied average current density provided at step 910.

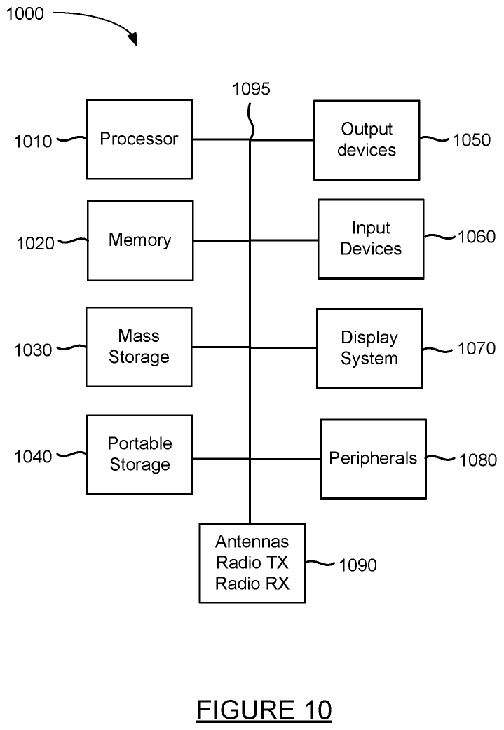

FIG. 10 is a block diagram of a computing environment for implementing in the present technology. System 1000 of FIG. 10 may be implemented in the contexts of the likes of machines that implement battery charging source 120 and battery powered system 110. The computing system 1000 of FIG. 10 includes one or more processors 1010 and memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive, an optical disk drive, a flash drive, or other device, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a floppy disk, compact disk or Digital video disc, USB drive, memory card or stick, or other portable or removable memory, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1000 as shown in FIG. 10 includes output devices 1050. Examples of suitable output devices include speakers, printers, network interfaces, and monitors.

Display system 1070 may include a liquid crystal display (LCD) or other suitable display device. Display system 1070 receives textual and graphical information and processes the information for output to the display device. Display system 1070 may also receive input as a touch-screen.

Peripherals 1080 may include any type of computer support device to add additional functionality to the computer system. For example, peripheral device(s) 1080 may include a modem or a router, printer, and other device.

The system of 1000 may also include, in some implementations, antennas, radio transmitters and radio receivers 1090. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for modeling a battery cell to detect lithium plating potential, comprising:
setting a lithium ion concentration for a modeled battery by a battery management system on a battery powered system, the battery model providing a model for a battery cell on the battery powered system;
predicting a temperature of the battery cell on battery powered system and setting the modeled battery temperature as the battery cell temperature;
setting material properties for the modeled battery representing a multiple particular model, the material properties based at least in part on the modeled battery temperature;
iteratively determining potential distribution and current density for the modeled battery by the battery management system, wherein the potential distribution and current density for the modeled battery is iteratively determined by the battery management system during cell life; and
calculating a lithium plating potential for the modeled battery by the battery management system based at least in part on the potential distribution.

2. The method of claim 1, wherein the potential distribution and current density for the modeled battery is iteratively determined by the battery management system during cell life.

3. The method of claim 1, wherein setting material properties includes:
estimating an actual lithium ion concentration in a battery cell within a battery powered system; and
setting the estimated lithium ion concentration as the lithium ion concentration for the modeled battery.

4. The method of claim 1, wherein the modeled battery material properties are based at least in part on the set lithium ion concentration.

5. The method of claim 1, wherein the modeled battery material properties include a diffusion within particles and a diffusion within electrolytes.

6. The method of claim 1, wherein the modeled battery material properties include a conductivity within an electrolyte and an electrode reaction rate constant.

7. The method of claim 1, wherein the potential distribution includes an electrode potential and an electrolyte potential.

8. The method of claim 1, comprising modifying a charging process for the battery cell by the battery management system based on the calculated lithium plating potential.

9. The method of claim 1, wherein iteratively determining potential distribution and current density by the battery management system includes:
setting an average applied current density for the modeled battery;
calculating an electrolyte potential distribution and an electrode potential distribution for a cathode and an electrode of the modeled battery;
calculating a new local current distribution for the modeled battery; and
repeating the steps of setting an average applied current density, calculating an electrolyte potential distribution and an electrode potential distribution, and calculating a new local current distribution for the modeled battery until the local current distribution converges.

10. A non-transitory computer readable storage medium having embodied thereon a program, the program being executable by a processor to perform a method for modeling a battery cell to detect lithium plating potential, the method comprising:
setting a lithium ion concentration for a modeled battery by a battery management system on a battery powered system, the battery model providing a model for a battery cell on the battery powered system;
detecting a temperature of the battery cell on battery powered system and setting the modeled battery temperature as the battery cell temperature;
setting material properties for the modeled battery representing a multiple particular model, the material properties based at least in part on the modeled battery temperature;
iteratively determining potential distribution and current density for the modeled battery by the battery management system, wherein the potential distribution and current density for the modeled battery is iteratively determined by the battery management system during cell life; and
calculating a lithium plating potential for the modeled battery by the battery management system based at least in part on the potential distribution.

11. The non-transitory computer readable storage medium of claim 10, wherein the potential distribution and current density for the modeled battery is iteratively determined by the battery management system during cell life;

12. The non-transitory computer readable storage medium of claim 10, wherein setting material properties includes:
estimating an actual lithium ion concentration in a batter cell within a battery powered system; and
setting the estimated lithium ion concentration as the lithium ion concentration for the modeled battery.

13. The non-transitory computer readable storage medium of claim 10, wherein the potential distribution includes an electrode potential and an electrolyte potential.

14. The non-transitory computer readable storage medium of claim 10, comprising modifying a charging process for the battery cell by the battery management system based on the calculated lithium plating potential.

15. The non-transitory computer readable storage medium of claim 10, wherein iteratively determining potential distribution and current density by the battery management system includes:
setting an average applied current density for the modeled battery;
calculating an electrolyte potential distribution and an electrode potential distribution for a cathode and an electrode of the modeled battery;
calculating a new local current distribution for the modeled battery; and
repeating the steps of setting an average applied current density, calculating an electrolyte potential distribution and an electrode potential distribution, and calculating a new local current distribution for the modeled battery until the local current distribution converges, wherein the steps of setting an average applied current density, calculating an electrolyte potential distribution, and calculating a new local current are performed by the battery management system during cell life, the model for the modeled battery representing a multiple particular model.

16. A system for modeling a battery cell to detect lithium plating potential, comprising:
one or more processors,
memory, and
one or more modules stored in memory and executable by the one or more processors to set a lithium ion concentration for a modeled battery by a battery management system on a battery powered system, the battery model providing a model for a battery cell on the battery powered system, detect a temperature of the battery cell on battery powered system and setting the modeled battery temperature as the battery cell temperature, set material properties for the modeled battery based at least in part on the modeled battery temperature, iteratively determine potential distribution and current density for the modeled battery by the battery management system, and calculate a lithium plating potential for the modeled battery by the battery management system based at least in part on the potential distribution.

17. The system of claim 16, wherein the potential distribution and current density for the modeled battery is iteratively determined by the battery management system during cell life.

18. The system of claim 16, wherein setting material properties includes:
estimating an actual lithium ion concentration in a batter cell within a battery powered system; and
setting the estimated lithium ion concentration as the lithium ion concentration for the modeled battery.

19. The system of claim 16, the one or more modules further executable to modify a charging process for the battery cell by the battery management system based on the calculated lithium plating potential.

20. The system of claim 16, wherein iteratively determining potential distribution and current density by the battery management system includes:
setting an average applied current density for the modeled battery;
calculating an electrolyte potential distribution and an electrode potential distribution for a cathode and an electrode of the modeled battery;
calculating a new local current distribution for the modeled battery; and
repeating the steps of Setting an average applied current density, calculating an electrolyte potential distribution and an electrode potential distribution, and calculating a new local current distribution for the modeled battery until the local current distribution converges.
